(19) United States
(12) Patent Application Publication
(10) Pub. No.: US 2026/0085217 A1
(43) Pub. Date: Mar. 26, 2026

(54) ORGANIC SILICON RESIN TOUGHENING AGENT, SINGLE-COMPONENT HIGH-STRENGTH EPOXY STRUCTURAL ADHESIVE, AND PREPARATION METHODS FOR BOTH

(71) Applicants: GUANGZHOU BAIYUN TECHNOLOGY CO., LTD., Guangdong (CN); GUANGDONG BAIYUN TECHNOLOGY CO., LTD., Guangdong (CN)

(72) Inventors: Jianjun CHEN, Guangdong (CN); Xingyuan LOU, Guangdong (CN); Chaobo FENG, Guangdong (CN); Canguang LI, Guangdong (CN); Xiangwei WANG, Guangdong (CN); Hengchao HUANG, Guangdong (CN); Mingsong MIAO, Guangdong (CN); Chunxiu CHEN, Guangdong (CN)

(73) Assignees: GUANGZHOU BAIYUN TECHNOLOGY CO., LTD., Guangdong (CN); GUANGDONG BAIYUN TECHNOLOGY CO., LTD., Guangdong (CN)

(21) Appl. No.: 19/403,979

(22) Filed: Nov. 30, 2025

Related U.S. Application Data
(63) Continuation of application No. PCT/CN2023/140685, filed on Dec. 21, 2023.

(30) Foreign Application Priority Data
Aug. 21, 2023 (CN) 202311054047.1

(51) Int. Cl. C09J 163/00; C08G 59/24; C08G 59/32; C08G 59/38; C08G 59/40; C08G 59/68; C08G 77/04; C08G 77/08; C08G 77/12; C08K 3/26; C08K 7/26; C09J 11/04

(52) U.S. Cl. CPC C09J 163/00; C08G 59/245; C08G 59/3227; C08G 59/3281; C08G 59/38; C08G 59/4021; C08G 59/686; C08G 77/045; C08G 77/08; C08G 77/12; C09J 11/04; C08K 2003/265; C08K 7/26

(57) ABSTRACT

An organic silicon resin toughening agent, a single-component high-strength epoxy structural adhesive, and the preparation method thereof. The organic silicon resin toughening agent is prepared by reacting epoxy modified hydrogen-containing silicone oil with vinyl six-membered cyclic oligomeric silsesquioxane; The epoxy modified hydrogen-containing silicone oil is prepared by reacting allyl alcohol glycidyl ether with dihydrogen-terminated hydrogen-containing silicone oil. The organic silicon resin toughening agent with a circular network structure unit synthesized by the present disclosure has better high and low temperature resistance compared to toughening agents such as nitrile rubber and core-shell structure rubber. While improving the toughness of single-component high-strength epoxy structural adhesive, it can significantly enhance the high and low temperature resistance of single-component high-strength epoxy structural adhesive.

### CROSS-REFERENCE TO RELATED APPLICATION

This application is a continuation of international application of PCT application serial no. PCT/CN2023/140685, filed on Dec. 21, 2023, which claims the priority benefit of China application no. 202311054047.1, filed on Aug. 21, 2023. The entirety of each of the above-mentioned patent applications is hereby incorporated by reference herein and made a part of this specification.

### TECHNICAL FIELD

The present disclosure relates to the field of adhesives, particularly to an organic silicon resin toughening agent, a single-component high-strength epoxy structural adhesive, and preparation methods thereof.

### BACKGROUND

Epoxy structural adhesive has the advantages of high bonding strength and wide application range. In the automotive field, it can be widely used for bonding automotive body structural components and parts, which is beneficial for improving body strength while reducing overall vehicle quality. However, epoxy adhesives without toughening modification have high brittleness, poor impact resistance, and low peel strength. The use of toughening agents such as nitrile rubber and core-shell structure rubber can improve the toughness of epoxy structural adhesive, but at the same time, it can also reduce the heat resistance of epoxy structural adhesive.

### SUMMARY

In order to overcome the above problems, the present disclosure discloses an organic silicon resin toughening agent with excellent high and low temperature resistance, which can be used for toughening modification of epoxy resin and is conducive to improving the toughness and high and low temperature resistance of epoxy resin.

The organic silicon resin toughening agent of present disclosure includes the following technical solutions.

An organic silicon resin toughening agent, with following structural formula:

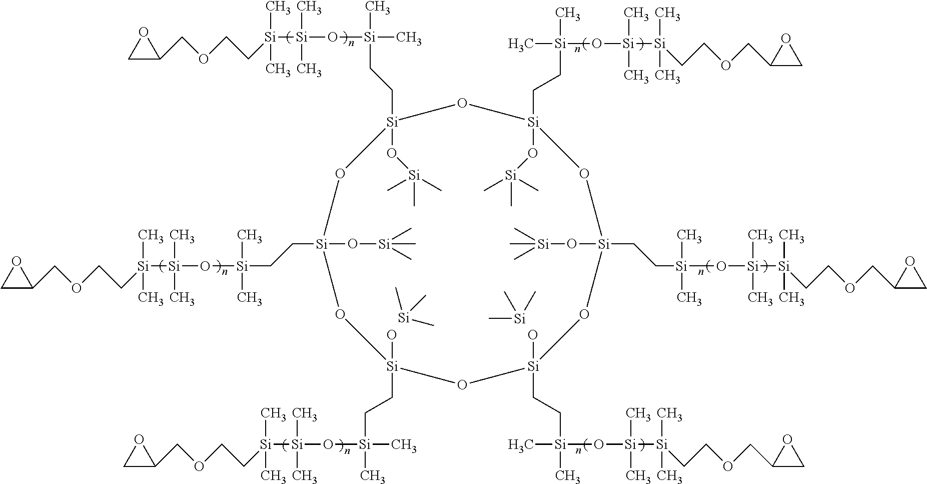

wherein, 50≤n≤300.

In some embodiments, 100≤n≤150.

An organic silicon resin toughening agent, being prepared by reacting epoxy-modified hydrogen-containing silicone oil and vinyl six-membered cyclic oligomeric silsesquioxane; wherein the epoxy-modified hydrogen-containing silicone oil is prepared by reacting allyl alcohol glycidyl ether and dihydrogen-terminated hydrogen-containing silicone oil;
a structural formula of the vinyl six-membered cyclic oligomeric silsesquioxane is:

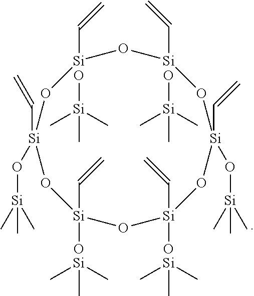

In some embodiments, a molar ratio of allyl alcohol glycidyl ether, dihydrogen-terminated hydrogen-containing silicone oil, and vinyl six-membered cyclic oligomeric silsesquioxane is 5 to 7:5 to 7:1.

In some embodiments, the molar ratio of allyl alcohol glycidyl ether, dihydrogen-terminated hydrogen-containing silicone oil, and vinyl six-membered cyclic oligomeric silsesquioxane is 6:6:1.

In some embodiments, the dihydrogen-terminated hydrogen-containing silicone oil has a hydrogen content of 0.09 mmol/g to 0.52 mmol/g at both ends.

In some embodiments, the dihydrogen-terminated hydrogen-containing silicone oil has a hydrogen content of 0.15 mmol/g to 0.25 mmol/g at both ends.

In some embodiments, the vinyl six-membered cyclic oligomeric silsesquioxane is obtained by reacting a potassium/copper salt complex of hexavinylcyclohexasilanol with trimethylchlorosilane; and the potassium/copper salt complex of hexavinylcyclohexasilanol is obtained by reacting vinyltrimethoxysilane with a base and then reacting with copper chloride dihydrate.

In some embodiments, the mass ratio of the potassium/copper salt complex of hexavinylcyclohexasilanol to the trimethylchlorosilane is 1:1 to 1.5.

In some embodiments, a mass ratio of vinyltrimethoxysilane, base, and copper chloride dihydrate is 1:0.4 to 0.5:0.3 to 0.4.

In some embodiments, the base is sodium hydroxide and/or potassium hydroxide.

In some embodiments, a preparation method of the vinyl six-membered cyclic oligomeric silsesquioxane comprises the following steps:
step 1: dissolving the vinyltrimethoxysilane in methanol, then adding the base, stirring evenly, heating and refluxing for 20 min to 30 min, adding a methanol solution containing the dihydrate copper chloride, refluxing for 20 min to 30 min, cooling down, filtering out the potassium chloride salt, and refrigerating the mixture at 5° C. to 10° C. to obtain crystals of the potassium/copper salt complex of hexavinylcyclohexasilanol;
step 2: adding the crystals of the potassium/copper salt complex crystal of hexavinylcyclohexasilanol and n-hexane solvent into the reaction vessel, adding the n-hexane solution containing the trimethylchlorosilane dropwise into the reaction vessel, stirring, refluxing for 8 h to 16 h, followed by post-treatment to obtain the vinyl six-membered cyclic oligomeric silsesquioxane.

The present disclosure also provides a method for preparing an organic silicon resin toughening agent, comprising the following steps:
adding the dihydrogen-terminated hydrogen-containing silicone oil and an appropriate amount of Pt catalyst into a reactor, stirring evenly, then adding the allyl alcohol glycidyl ether dropwise, and then reacting at a temperature of 40° C. to 60° C. for 1 h to 2 h to obtain the epoxy-modified hydrogen-containing silicone oil;
reacting the epoxy-modified hydrogen-containing silicone oil with the vinyl six-membered cyclic oligomeric silsesquioxane at 50° C. to 70° C. and under the action of Pt catalyst for 1 h to 2 h to obtain the organic silicon resin toughening agent.

The present disclosure also provides a single-component high-strength epoxy structural adhesive which can be used for automobile body bonding and a preparation method thereof. The single-component high-strength epoxy structural adhesive prepared by the present disclosure has good toughness and resistance to high and low temperatures, and has excellent adhesion to metal materials such as steel and aluminum, making it particularly suitable for structural bonding applications in the automotive field.

The single-component high-strength epoxy structural adhesive of the present disclosure includes the following technical solutions.

A single-component high-strength epoxy structural adhesive, being prepared from raw materials comprising the following components by weight:

| | |
|---|---|
| epoxy resin | 20 to 50 parts |
| silicone resin toughening agent | 25 to 40 parts |
| filler | 10 to 40 parts |
| curing agent | 5 to 10 parts |
| accelerator | 0.5 to 2 parts. |

In some embodiments, the single-component high-strength epoxy structural adhesive, being prepared from raw materials comprising the following components by weight:

| | | |
|---|---|---|
| epoxy resin | 35 to 45 | parts |
| silicone resin toughening agent | 25 to 35 | parts |
| filler | 18 to 26 | parts |
| curing agent | 7 to 9 | parts |
| accelerator | 0.5 to 2 | parts. |

In some embodiments, the single-component high-strength epoxy structural adhesive, being prepared from raw materials comprising the following components by weight:

| | | |
|---|---|---|
| epoxy resin | 38 to 42 | parts |
| silicone resin toughening agent | 28 to 32 | parts |
| filler | 20 to 22 | parts |
| curing agent | 7 to 9 | parts |
| accelerator | 0.8 to 2 | parts. |

In some embodiments, the epoxy resin is selected from any one or more combinations of bisphenol A diglycidyl ether, bisphenol F diglycidyl ether, castor oil modified epoxy resin, polyurethane modified epoxy resin, organosilicon modified epoxy resin, and acrylate modified epoxy resin.

In some embodiments, the filler is selected from one or more combinations of nano calcium carbonate, heavy calcium carbonate, silica micro powder, gas-phase silica, alumina, aluminum hydroxide, talc powder, and bentonite.

In some embodiments, the filler is selected from a combination of 1:9 to 10 gas-phase silica and nano calcium carbonate.

In some embodiments, the curing agent is dicyandiamide or hydrazide.

In some embodiments, the accelerator is selected from any one or more combinations of substituted urea, imidazole, and imidazole derivatives.

The present disclosure also provides a method for preparing the single-component high-strength epoxy structural adhesive, including the following technical solutions.

A method for preparing the single-component high-strength epoxy structural adhesive, comprising the following steps: mixing the epoxy resin, the organic silicone resin toughening agent, the filler, the curing agent, and the accelerator, stirring evenly to obtain the single-component high-strength epoxy structural adhesive.

The present disclosure synthesizes an organic silicon resin toughening agent containing epoxy groups and a cyclic network structure using allyl alcohol glycidyl ether, dihydrogen-terminated hydrogen-containing silicone oil, and vinyl six-membered cyclic oligomeric silsesquioxane as raw materials, and prepares a single-component high-strength epoxy structural adhesive using the organic silicon resin toughening agent. Compared with existing technologies, the organic silicon resin toughening agent and the single-component high-strength epoxy structural adhesive of the present disclosure have the following beneficial effects:
1. The organic silicon resin toughening agent synthesized by the present disclosure contains multiple reactive epoxy groups, which are applied to single-component high-strength automotive epoxy structural adhesives. The presence of epoxy groups helps to improve the compatibility between silicone resin and epoxy resin systems. At the same time, from a microscopic perspective, there is a certain degree of incompatibility between the siloxane and epoxy segments during colloid curing, which can easily form island like structures with microphase separation, thereby effectively improving the strength and toughness of epoxy structural adhesives.
2. The organic silicon resin toughening agent with a circular network structure unit synthesized by the present disclosure has better high and low temperature resistance compared to toughening agents such as nitrile rubber and core-shell structure rubber. While improving the toughness of single-component high-strength epoxy structural adhesive, it can significantly enhance the high and low temperature resistance of single-component high-strength epoxy structural adhesive.

### DESCRIPTION OF THE EMBODIMENTS

The following will further illustrate the technical solutions of the present disclosure through specific embodiments. Technicians in this field should understand that the described embodiments are only intended to help understanding the present disclosure and should not be considered as specific limitations to the present disclosure.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure.

The terms “including” and “having” of the present disclosure, as well as any variations thereof, are intended to cover non-exclusive inclusions. For examples, a process, method, device, product, or equipment that includes a series of steps is not limited to the listed steps or modules, but optionally includes steps that are not listed, or alternatively includes other steps inherent to these processes, methods, products, or devices.

The term “multiple” mentioned in the present disclosure refers to two or more. “And/or” describes the relationship of the associated objects, indicating that there can be three types of relationships. For example, A and/or B can represent: the existence of A alone, the coexistence of A and B, and the existence of B alone. The character “/” generally indicates that the associated objects are in an “or” relationship.

The preparation method of the organic silicon resin toughening agent described in the present disclosure is as follows:
a. A certain amount of dihydrogen-terminated hydrogen-containing silicone oil (with a hydrogen content of 0.09 mmol/g to 0.52 mmol/g, corresponding to 50≤n≤300) and an appropriate amount of Castell platinum catalyst were added to the reactor and stirred evenly. An equimolar amount of allyl alcohol glycidyl ether was slowly and uniformly added within 2 h to 3 h. Then the mixture was reacted at 50° C. for 1.5 h to obtain epoxy modified hydrogen containing silicone oil; the reaction principle was as follows:

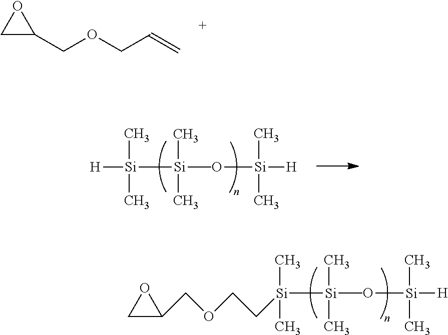

The obtained epoxy modified hydrogen-containing silicone oil was analyzed by FT-IR spectroscopy, and it was found that the characteristic stretching vibration peak of Si—O—Si appeared at 1095 cm⁻¹; the characteristic peak with higher intensity and sharper shape at 915 cm⁻¹ should be attributed to the stretching vibration peak of C—O in the epoxy group, and the characteristic peak at 2160 cm⁻¹ should be attributed to the characteristic absorption peak of Si—H. No C═C characteristic peak was found near 1650 cm⁻¹, indicating an addition reaction between hydrogen-containing silicone oil and allyl alcohol glycidyl ether.

b. Vinyl Six-Membered Cyclic Oligomeric Silsesquioxane was Prepared by a Two-Step Reaction:

Step 1:100 g of vinyltrimethoxysilane was dissolved in 600 mL of methanol, then 45 g of potassium oxide was added. The mixture was stirred evenly, heated and refluxed for 15 min to 20 min. 100 mL of methanol solution was added, which containing 38 g of copper chloride dihydrate, refluxed for 25 min to 30 min. After cooling to room temperature (25° C.), the potassium chloride salt was filtered out, and the mixture was refrigerated in a refrigerator (10° C.) for 2 h to obtain blue crystals {K₂[(ViSiO₂)₆K₂CuO₄ (O₂SiVi)₆]}0.5 (CH₃OH) of the potassium/copper salt complex of hexavinylcyclohexasilanol. FT-IR spectroscopy analysis revealed the appearance of stretching vibration peaks of vinyl C—H at 3053 cm⁻¹ and 2951 cm⁻¹; the characteristic peak at 990 cm⁻¹ was the out of plane deformation vibration peak of vinyl C—H; the broad peak at 3416 cm⁻¹ was the O—H stretching vibration peak of intermolecular oxygen bond formation by —OH in water and alcohol molecules in the crystal, and the stretching vibration peaks of (Si—O, C—O) at 1100-1 and 1080 cm⁻¹ were also observed.

Step 2:30 g of potassium/copper salt complex of hexavinylcyclohexasilanol and 200 g of n-hexane solvent were added into a three-necked flask at one time. 38.6 g trimethylchlorosilane was dissolved in 100 mL of n-hexane and added dropwise to the flask. The mixture was stirred vigorously and refluxed for 12 h. After cooling to room temperature and filtering, the filtrate was washed with water until neutral, dried over anhydrous sodium sulfate, filtered, and the solvent was removed by rotary evaporation to obtain a colorless and transparent oily substance vinyl six-membered cyclic oligomeric silsesquioxane. FT-IR spectroscopy analysis revealed the appearance of Si—O—Si characteristic stretching vibration peak at 1103 cm⁻¹, C═C characteristic absorption peak at 1652m⁻¹, anti-symmetric stretching vibration peak of methyl group in —Si(CH₃) 3 at 2962 cm⁻¹, symmetric deformation vibration peak and in-plane rocking vibration peak of Si—CH₃ in —Si(CH₃) 3 at 1251 cm⁻¹ and 845 cm⁻¹, respectively. The appearance of —Si(CH₃) vibration peak indicated that potassium/copper salt complex of hexavinylcyclohexasilanol reacted with trimethylchlorosilane, and the metal ions in the complex crystal were successfully stripped away.

c. The epoxy modified hydrogen-containing silicone oil obtained in step a and the vinyl six-membered cyclic oligomeric silsesquioxane obtained in step b were added to the reactor in a molar ratio of 6:1. The mixture was added an appropriate amount of Castell platinum catalyst, stirred evenly, and reacted at 60° C. for 1.5 h to prepare an organic silicon resin toughening agent.

The reaction principle is as follows:

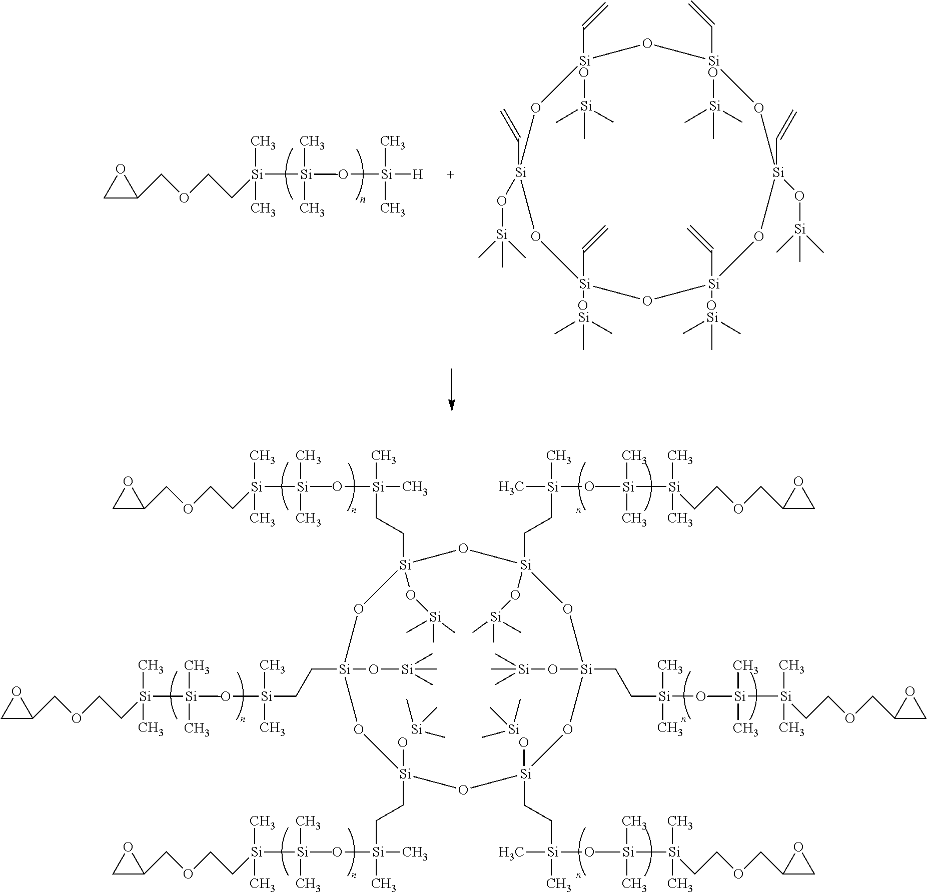

FT-IR spectroscopy analysis was performed on the obtained organic silicone resin toughening agent, and it was found that the characteristic stretching vibration peak of Si—O—Si appeared at 1096 cm⁻¹. The characteristic peak at 2962 cm⁻¹ was the anti-symmetric stretching vibration peak of C—H in the methyl group of —Si(CH₃). The characteristic peaks at 1251 cm⁻¹ and 845 cm⁻¹ were the symmetric deformation vibration peak and in-plane oscillation vibration peak of Si—CH₃ in —Si(CH₃). The high intensity and sharp shaped characteristic peak at 910 cm⁻¹ should be attributed to the stretching vibration peak of C—O in the epoxy group. The characteristic absorption peak of Si—H at 2160 cm⁻¹ and the C═C characteristic peak at 1652 cm⁻¹ disappeared, indicating the organic silicon resin toughening agent with the above-mentioned structure was obtained.

### Embodiment 1

The single-component high-strength epoxy structural adhesive provided in this embodiment was prepared from the following components by weight:

| | | |
|---|---|---|
| bisphenol A diglycidyl ether | 40 | parts |
| organic silicon resin toughening agent | 30 | parts |
| nano calcium carbonate | 19 | parts |
| fumed silica | 2 | parts |
| dicyandiamide | 8 | parts |
| substituted urea | 1 | part; |

wherein, dihydrogen-terminated hydrogen-containing silicone oil with hydrogen content of 0.2 mmol/g (i.e. n=133) was used in the preparation process of organic silicone resin toughening agent.

The preparation method was as follows: the bisphenol A diglycidyl ether epoxy resin, organic silicon resin toughening agent, nano calcium carbonate, fumed silica, curing agent dicyandiamide, and substituted urea accelerator were mixed and stirred evenly, and discharged to obtain the single-component high-strength epoxy structural adhesive.

### Embodiment 2

The single-component high-strength epoxy structural adhesive provided in this embodiment was prepared from the following components by weight:

| | | |
|---|---|---|
| bisphenol A diglycidyl ether | 35 | parts |
| organic silicon resin toughening agent | 30 | parts |
| nano calcium carbonate | 26 | parts |
| dicyandiamide | 8 | parts |
| substituted urea | 1 | part; |

wherein, dihydrogen-terminated hydrogen-containing silicone oil with hydrogen content of 0.5 mmol/g (i.e. n=52) was used in the preparation process of organic silicone resin toughening agent.

The preparation method was as follows: the bisphenol A diglycidyl ether epoxy resin, organic silicon resin toughening agent, nano calcium carbonate, curing agent dicyandiamide, and substituted urea accelerator were mixed and stirred evenly, and discharged to obtain the single-component high-strength epoxy structural adhesive.

### Embodiment 3

The single-component high-strength epoxy structural adhesive provided in this embodiment was prepared from the following components by weight:

| | | |
|---|---|---|
| DER791 Polyurethane modified epoxy resin | 40 | parts |
| organic silicon resin toughening agent | 30 | parts |
| nano calcium carbonate | 20 | parts |
| dicyandiamide | 8 | parts |
| substituted urea | 2 | parts; |

wherein, dihydrogen-terminated hydrogen-containing silicone oil with hydrogen content of 0.2 mmol/g (i.e. n=133) was used in the preparation process of organic silicone resin toughening agent. The epoxy equivalent of Dow DER791 polyurethane modified epoxy resin in the United States is 235 to 270, and the viscosity at 25° C. is 35000 cps to 45000 cps.

The preparation method was as follows: the DER791 polyurethane modified epoxy resin, organic silicon resin toughening agent, nano calcium carbonate, curing agent dicyandiamide, and substituted urea accelerator were mixed and stirred evenly, and discharged to obtain the single-component high-strength epoxy structural adhesive.

### Embodiment 4

The single-component high-strength epoxy structural adhesive provided in this embodiment was prepared from the following components by weight:

| | | |
|---|---|---|
| Bisphenol F diglycidyl ether | 35 | parts |
| organic silicon resin toughening agent | 35 | parts |
| silica fume | 22 | parts |
| dicyandiamide | 7 | parts |
| substituted urea | 1 | part; |

wherein, dihydrogen-terminated hydrogen-containing silicone oil with hydrogen content of 0.1 mmol/g (i.e. n=268) was used in the preparation process of organic silicone resin toughening agent.

The preparation method was as follows: Bisphenol F diglycidyl ether, organic silicon resin toughening agent, silica fume, curing agent dicyandiamide, and substituted urea accelerator were mixed and stirred evenly, and discharged to obtain the single-component high-strength epoxy structural adhesive.

### Embodiment 5

The single-component high-strength epoxy structural adhesive provided in this embodiment was prepared from the following components by weight:

| | | |
|---|---|---|
| Bisphenol F diglycidyl ether | 30 | parts |
| organic silicon resin toughening agent | 40 | parts |
| nano calcium carbonate | 17 | parts |
| fumed silica | 3 | parts |
| dicyandiamide | 8 | parts |
| substituted urea | 2 | parts; |

wherein, dihydrogen-terminated hydrogen-containing silicone oil with hydrogen content of 0.3 mmol/g (i.e. n=88) was used in the preparation process of organic silicone resin toughening agent.

The preparation method was as follows: Bisphenol F diglycidyl ether, organic silicon resin toughening agent, nano calcium carbonate, fumed silica, curing agent dicyandiamide, and substituted urea accelerator were mixed and stirred evenly, and discharged to obtain the single-component high-strength epoxy structural adhesive.

### Comparative Embodiment 1

The single-component high-strength epoxy structural adhesive provided in this comparative embodiment was prepared from the following components by weight:

| | | |
|---|---|---|
| bisphenol A diglycidyl ether | 50 | parts |
| nano calcium carbonate | 36 | parts |
| fumed silica | 2 | parts |
| dicyandiamide | 10 | parts |
| substituted urea | 2 | parts; |

The preparation method was as follows: the bisphenol A diglycidyl ether epoxy resin, nano calcium carbonate, fumed silica, curing agent dicyandiamide, and substituted urea accelerator were mixed and stirred evenly, and discharged to obtain the single-component high-strength epoxy structural adhesive.

### Comparative Embodiment 2

The single-component high-strength epoxy structural adhesive provided in this comparative embodiment was prepared from the following components by weight:

| | | |
|---|---|---|
| bisphenol A diglycidyl ether | 40 | parts |
| CTBN toughening agent | 30 | parts |
| nano calcium carbonate | 19 | parts |
| fumed silica | 2 | parts |
| dicyandiamide | 8 | parts |
| substituted urea | 1 | part; |

The preparation method was as follows: the bisphenol A diglycidyl ether epoxy resin, CTBN toughening agent, nano calcium carbonate, fumed silica, curing agent dicyandiamide, and substituted urea accelerator were mixed and stirred evenly, and discharged to obtain the single-component high-strength epoxy structural adhesive.

### Comparative Embodiment 3

The single-component high-strength epoxy structural adhesive provided in this comparative embodiment was prepared from the following components by weight:

| | | |
|---|---|---|
| Bisphenol F diglycidyl ether | 35 | parts |
| CTBN toughening agent | 35 | parts |
| silica fume | 22 | parts |
| dicyandiamide | 7 | parts |
| substituted ureas | 1 | part; |

The preparation method was as follows: the Bisphenol F diglycidyl ether, CTBN toughening agent, silica fume, curing agent dicyandiamide, and substituted urea accelerator was mixed and stirred evenly, and discharged to obtain the single-component high-strength epoxy structural adhesive

### Comparative Embodiment 4

The single-component high-strength epoxy structural adhesive provided in this comparative embodiment was prepared from the following components by weight:

| | | |
|---|---|---|
| bisphenol A diglycidyl ether | 40 | parts |
| toughening agent | 30 | parts |
| nano calcium carbonate | 19 | parts |
| fumed silica | 2 | parts |
| dicyandiamide | 8 | parts |
| substituted urea | 1 | part; |

wherein, the toughening agent was the epoxy modified hydrogen containing silicone oil prepared in step a, which the hydrogen content of the dihydrogen-terminated hydrogen-containing silicone oil was 0.2 mmol/g in the preparation process.

The preparation method was as follows: the bisphenol A diglycidyl ether, toughening agent, nano calcium carbonate, fumed silica, curing agent dicyandiamide, and substituted urea accelerator were mixed and stirred evenly, and discharged to obtain the single-component high-strength epoxy structural adhesive.

### Comparative Embodiment 5

The single-component high-strength epoxy structural adhesive provided in this comparative embodiment was prepared from the following components by weight:

| | | |
|---|---|---|
| bisphenol A diglycidyl ether | 40 | parts |
| toughening agent | 30 | parts |
| nano calcium carbonate | 19 | parts |
| fumed silica | 2 | parts |
| dicyandiamide | 8 | parts |
| substituted urea | 1 | part; |

Wherein, the preparation method of toughening agent was as follows:

Dihydrogen-terminated hydrogen-containing silicone oil with a hydrogen content of 0.2 mmol/g and the vinyl six-membered cyclic oligomeric silsesquioxane obtained in step b were added to the reactor in a molar ratio of 6:1. The mixture was added an appropriate amount of Castell platinum catalyst, stirred evenly, and reacted at 60° C. to prepare a toughening agent.

The preparation method was as follows: the bisphenol A diglycidyl ether, toughening agent, nano calcium carbonate, fumed silica, curing agent dicyandiamide, and substituted urea accelerator were mixed and stirred evenly, and discharged to obtain the single-component high-strength epoxy structural adhesive.

The following performance tests were performed on the epoxy structural adhesives prepared in Embodiments 1 to 5 and Comparative embodiments 1 to 5:

Cold-rolled steel was used as the substrate in the test.

Shear strength: tested according to GB/T 7124 method.

T-type peel strength: tested according to the method of GB/T 2791.

Low temperature impact peel strength at −40° C.: tested according to the method of GB/T 36877, with a set temperature of −40° C.

80° C. impact peel strength: tested according to the method of GB/T 36877, with a set temperature of 80° C.

Heat resistant aging shear strength: shear strength test specimens were prepared according to the GB/T 7124 method, and cured under baking conditions of (170±2° C.) for 20 min. After finished, the specimens were taken out and left in a standard state for 24 h, placed in a 130° C. environmental chamber for 168 h, and then removed at room temperature for 24 h. The shear strength were measured according to the GB/T 7124 method.

High and low temperature alternating shear strength: shear strength test specimens were prepared according to the GB/T 7124 method, and cured under baking conditions of (170±2° C.) for 20 min. After finished, the specimens were taken out and left in a standard state for 24 h, and treated for 4 cycles according to the following conditions, then taken out, and left stand in a standard state for 24 h. The shear strength was measured according to the GB/T 7124 method.

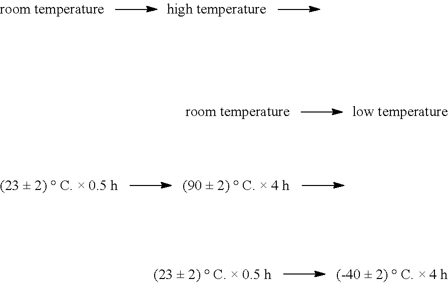

The test results are shown in Table 1.

TABLE 1
Performance parameters of single-component high-strength epoxy structural adhesive

| | | T-type | Low temperature | 80° C. | Heat | High and low |
|---|---|---|---|---|---|---|
| | Shear | peel | impact peel | impact peel | resistant | temperature |
| | strength | strength | strength at −40° | strength | aging shear | alternating shear |
| Program | MPa | N/mm | C. N/mm | N/mm | strength MPa | strength MPa |
| embodiment 1 | 42 | 11.5 | 33.5 | 46 | 41 | 41.6 |
| embodiment 2 | 38 | 9 | 31 | 42 | 37.1 | 37.3 |
| embodiment 3 | 40 | 12 | 32.2 | 42.5 | 37.5 | 37.6 |
| embodiment 4 | 37 | 9 | 28 | 37 | 35.7 | 35 |
| embodiment 5 | 35 | 8 | 27 | 35 | 33.6 | 33.2 |
| Comparative | 21 | 4 | 12 | 20.7 | 16.2 | 16.5 |
| embodiment 1 | | | | | | |
| Comparative | 37 | 9 | 29.2 | 34 | 30.6 | 30.8 |
| embodiment 2 | | | | | | |
| Comparative | 30 | 6 | 22 | 29 | 26 | 26.3 |
| embodiment 3 | | | | | | |
| Comparative | 33 | 7 | 24 | 32 | 29.5 | 29.9 |
| embodiment 4 | | | | | | |
| Comparative | 27 | 5 | 17 | 27 | 23.5 | 23.7 |
| embodiment 5 | | | | | | |

From the results in Table 1, it can be seen that the single-component high-strength epoxy structural adhesives of embodiments 1 to 5 prepared using the organic silicon resin toughening agent synthesized by the present disclosure have relatively good shear strength and peel strength, and the 80° C. impact peel strength, heat-resistant aging shear strength, and high and low temperature alternating shear strength were all better than those of Comparative embodiments 1 to 5. In Comparative embodiment 1, no toughening agent was used. The shear strength and peel strength of the single-component high-strength epoxy structural adhesive were relatively low, mainly because the epoxy resin was brittle and prone to brittle fracture, unable to withstand large stresses, and ultimately exhibiting lower mechanical properties. CTBN carboxyl terminated liquid nitrile rubber were used to modify toughening in Comparative embodiments 2 and 3, and their mechanical properties were significantly improved compared to Comparative embodiment 1. However, compared to the epoxy structural adhesive modified with the organic silicon resin toughening agent of the present disclosure, its 80° C. impact peel strength and heat-resistant aging shear strength were relatively low. Compared to embodiments 1 to 3, embodiments 4 to 5 have lower mechanical properties, mainly due to the addition of excessive toughening agents while reducing the epoxy resin content, resulting in insufficient rigidity and lower strength of the prepared epoxy structural adhesive. Compared with embodiment 4, the mechanical properties in Comparative embodiment 3 were lower, especially lower heat resistance compared to the organic silicon resin toughening agent of the present disclosure. This was mainly because the toughening effect and heat resistance of CTBN carboxyl end liquid nitrile rubber were not as good as those of the organic silicon resin toughening agent of the present disclosure. Comparative embodiment 4 used the epoxy modified hydrogen-containing silicone oil prepared in Step a of the present disclosure as a toughening agent, which has a certain toughening effect. However, due to the lack of a circular network structure skeleton, the cohesive strength of the epoxy modified hydrogen containing silicone oil itself was not high, so the mechanical properties of the final prepared epoxy structural adhesive were also not high. The main difference between the toughening agent used in Comparative embodiment 5 and the organic silicone resin toughening agent used in embodiment 1 was that its end lacked reactive epoxy groups, resulting in poor compatibility with epoxy resin. Its reinforcement and toughening effect was far inferior to the silicone resin toughening agent containing six reactive epoxy groups in the present disclosure.

In summary, the use of the organic silicon resin toughening agent synthesized by the present disclosure could effectively improve the strength, toughness, and high and low temperature resistance of single-component high-strength epoxy structural adhesives, and could better enhance the durability of epoxy structural adhesives. When used in automobile bodies, it could better ensure the structural safety of automobiles.

The technical features of the embodiments above can be combined arbitrarily. To simplify the description, all possible combinations of the technical features of the embodiments above are not described. However, as long as there is no contradiction in the combination of these technical features, they should be considered to be within the scope of the specification.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

What is claimed is:

1. An organic silicon resin toughening agent, with following structural formula: 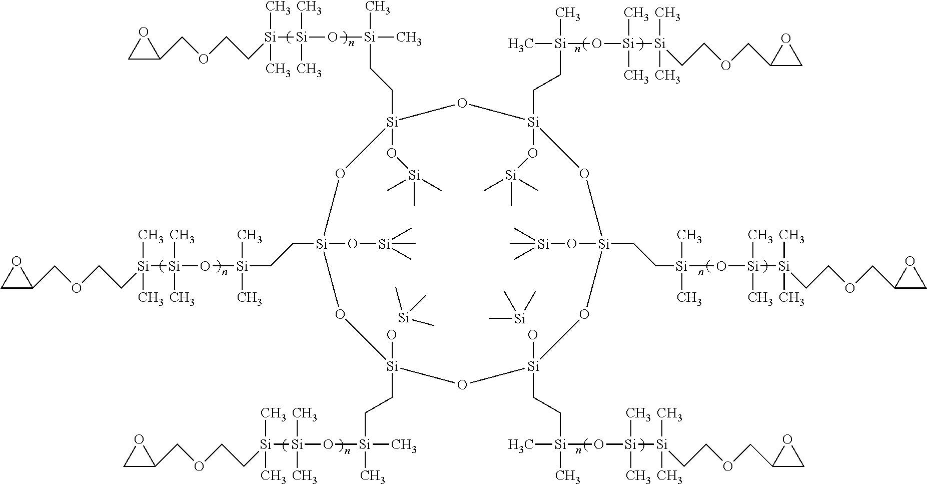
wherein, 50≤n≤300.

2. The organic silicon resin toughening agent according to claim 1, wherein 100≤n≤150.

3. An organic silicon resin toughening agent, being prepared by reacting epoxy-modified hydrogen-containing silicone oil and vinyl six-membered cyclic oligomeric silsesquioxane; wherein the epoxy-modified hydrogen-containing silicone oil is prepared by reacting allyl alcohol glycidyl ether and dihydrogen-terminated hydrogen-containing silicone oil;
wherein a structural formula of the vinyl six-membered cyclic oligomeric silsesquioxane is:

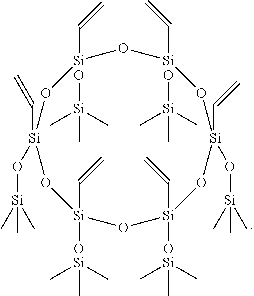

4. The organic silicon resin toughening agent according to claim 3, wherein a molar ratio of allyl alcohol glycidyl ether, dihydrogen-terminated hydrogen-containing silicone oil, and vinyl six-membered cyclic oligomeric silsesquioxane is 5 to 7:5 to 7:1.

5. The organic silicon resin toughening agent according to claim 4, wherein the molar ratio of allyl alcohol glycidyl ether, dihydrogen-terminated hydrogen-containing silicone oil, and vinyl six-membered cyclic oligomeric silsesquioxane is 6:6:1.

6. The organic silicon resin toughening agent according to claim 3, wherein the dihydrogen-terminated hydrogen-containing silicone oil has a hydrogen content of 0.09 mmol/g to 0.52 mmol/g.

7. The organic silicon resin toughening agent according to claim 6, wherein the dihydrogen-terminated hydrogen-containing silicone oil has a hydrogen content of 0.15 mmol/g to 0.25 mmol/g.

8. The organic silicon resin toughening agent according to claim 3, wherein the vinyl six-membered cyclic oligomeric silsesquioxane is obtained by reacting a potassium/copper salt complex of hexavinylcyclohexasilanol with trimethylchlorosilane in a mass ratio of 1:1 to 1.5; and the potassium/copper salt complex of hexavinylcyclohexasilanol is obtained by reacting vinyltrimethoxysilane with a base and then reacting with copper chloride dihydrate.

9. The organic silicon resin toughening agent according to claim 8, wherein the base is sodium hydroxide and/or potassium hydroxide; and/or,
a mass ratio of vinyltrimethoxysilane, base, and copper chloride dihydrate is 1:0.4 to 0.5:0.3 to 0.4.

10. The organic silicon resin toughening agent according to claim 8, wherein a preparation method of the vinyl six-membered cyclic oligomeric silsesquioxane comprises the following steps:
step 1: dissolving the vinyltrimethoxysilane in methanol, then adding the base, stirring evenly, heating and refluxing for 20 min to 30 min, adding a methanol solution containing dihydrate copper chloride, refluxing for 20 min to 30 min, cooling down, filtering out potassium chloride salt, and refrigerating the mixture at 5° C. to 10° C. to obtain crystals of the potassium/copper salt complex of hexavinylcyclohexasilanol;
step 2: adding the crystals of the potassium/copper salt complex of hexavinylcyclohexasilanol and n-hexane solvent into a reaction vessel, adding a n-hexane solution containing the trimethylchlorosilane dropwise into the reaction vessel, stirring, refluxing for 8 h to 16 h, followed by post-treatment to obtain the vinyl six-membered cyclic oligomeric silsesquioxane.

11. A method for preparing an organic silicon resin toughening agent according to claim 3, comprising the following steps:
adding the dihydrogen-terminated hydrogen-containing silicone oil and an appropriate amount of Pt catalyst into a reactor, stirring evenly, then adding the allyl alcohol glycidyl ether dropwise, and then reacting at a temperature of 40° C. to 60° C. for 1 h to 2 h to obtain the epoxy-modified hydrogen-containing silicone oil;
reacting the epoxy-modified hydrogen-containing silicone oil with the vinyl six-membered cyclic oligomeric silsesquioxane at 50° C. to 70° C. and under the action of Pt catalyst for 1 h to 2 h to obtain the organic silicon resin toughening agent.

12. A single-component high-strength epoxy structural adhesive, being prepared from raw materials comprising the following components by weight:

| | | |
|---|---|---|
| epoxy resin | 20 to 50 | parts |
| silicone resin toughening agent | 25 to 40 | parts |
| filler | 10 to 40 | parts |
| curing agent | 5 to 10 | parts |
| accelerator | 0.5 to 2 | parts; |

wherein, the organic silicon resin toughening agent is the organic silicon resin toughening agent according to claim 1.

13. The single-component high-strength epoxy structural adhesive according to claim 12, being prepared from raw materials comprising the following components by weight:

| | | |
|---|---|---|
| epoxy resin | 35 to 45 | parts |
| silicone resin toughening agent | 25 to 35 | parts |
| filler | 18 to 26 | parts |
| curing agent | 7 to 9 | parts |
| accelerator | 0.5 to 2 | parts. |

14. The single-component high-strength epoxy structural adhesive according to claim 13, being prepared from raw materials comprising the following components by weight:

| | | |
|---|---|---|
| epoxy resin | 38 to 42 | parts |
| silicone resin toughening agent | 28 to 32 | parts |
| filler | 20 to 22 | parts |
| curing agent | 7 to 9 | parts |
| accelerator | 0.8 to 2 | parts. |

15. The single-component high-strength epoxy structural adhesive according to claim 12, wherein the epoxy resin is selected from any one or more combinations of bisphenol A diglycidyl ether, bisphenol F diglycidyl ether, castor oil modified epoxy resin, polyurethane modified epoxy resin, organosilicon modified epoxy resin, and acrylate modified epoxy resin; and/or,
the filler is selected from one or more combinations of nano calcium carbonate, heavy calcium carbonate, silica micro powder, gas-phase silica, alumina, aluminum hydroxide, talc powder, and bentonite; and/or,
the curing agent is dicyandiamide or hydrazide; and/or,
the accelerator is selected from any one or more combinations of substituted urea, imidazole, and imidazole derivatives.
